(19) United States
(12) Patent Application Publication
(10) Pub. No.: US 2018/0118124 A1
(43) Pub. Date: May 3, 2018

(54) AUTOMOBILE GUN HOLSTER

(71) Applicant: Telor Products, LLC, Appling, GA (US)

(72) Inventor: David Leverett, Appling, GA (US)

(21) Appl. No.: 15/340,760

(22) Filed: Nov. 1, 2016

(51) Int. Cl. B60R 7/14; B60R 7/04; F41C 33/02; F41C 33/04; F42B 39/02

(52) U.S. Cl. CPC B60R 7/14; B60R 7/043; F42B 39/02; F41C 33/041; F41C 33/0236

(57) ABSTRACT

An automobile gun holster (10) is disclosed for use with an automobile seat (11) having a base portion (12) with a top surface, a peripheral sidewall surface and two front upper corners (22). The holster has a front panel (26) having a backing (27), a gun pocket (28) and an ammunition pocket (29). The holster also includes a split side strap (32) which extends from opposite sides of the front panel. The side strap includes a main portion (33) mounted about the seat's peripheral sidewall, and a top portion (41). The combination of the main portion 33 and top portions creates openings (44) therebetween within which the two front upper corners are captured. The holster includes a pair of bottom straps (46) which are mounted to and extend from the bottom edge of the front panel and are mounted to the bottom of the seat.

### TECHNICAL FIELD

This invention relates to gun holsters, and specifically to gun holsters adapted to be used in conjunction with an automobile seat.

### BACKGROUND OF THE INVENTION

Holsters are oftentimes used for carrying a gun or pistol on a user's body within reach of the user. These holsters may be place in the waistband of a pair of pants or strapped onto a person's torso or appendage, such as an ankle. Other holsters may be adapted to be placed within a pocket, handbag, or other personal item.

Some holsters are designed or formed to fit a particular style or model of gun so as to provide a secure and stable fit between the gun and holster. Other holsters may include a pouch of stretchable material to accommodate different sized or configured guns.

Oftentimes, a person carrying a gun may wish to have the gun within reach while driving an automobile. As such, people may place the gun within the glove box or console of the automobile. However, this is not a safe way of traveling with a gun as the gun may slide about the compartment. Also, placing the gun within a compartment does not allow for quick access of the gun in an emergency situation.

Gun holsters have recently been designed to be fitted to the seat of an automobile. These automobile gun holsters typically include a strap that lays upon the top surface of the seat, as shown in FIG. 1. This placement of the strap is uncomfortable as the person must sit upon the strap.

Accordingly, it is seen that a need remains for a gun holster that is able to be mounted within an automobile in a manner that does not compromise the comfort to the person within the automobile. It is to the provision of such therefore that the present invention is primarily directed.

### SUMMARY OF THE INVENTION

An automobile gun holster adapted for use with an automobile seat having a base and a backrest comprises a front panel including a gun pocket, and a flexible, adjustable side strap coupled to the front panel having a length to be wrapped about the peripheral sidewalls of an automobile seat base. The adjustable side strap being adjustable in length to accommodate automobile seat bases of different sizes.

### BRIEF DESCRIPTION OF THE DRAWING

FIG. 1 is a perspective view of a prior art automobile gun holster.

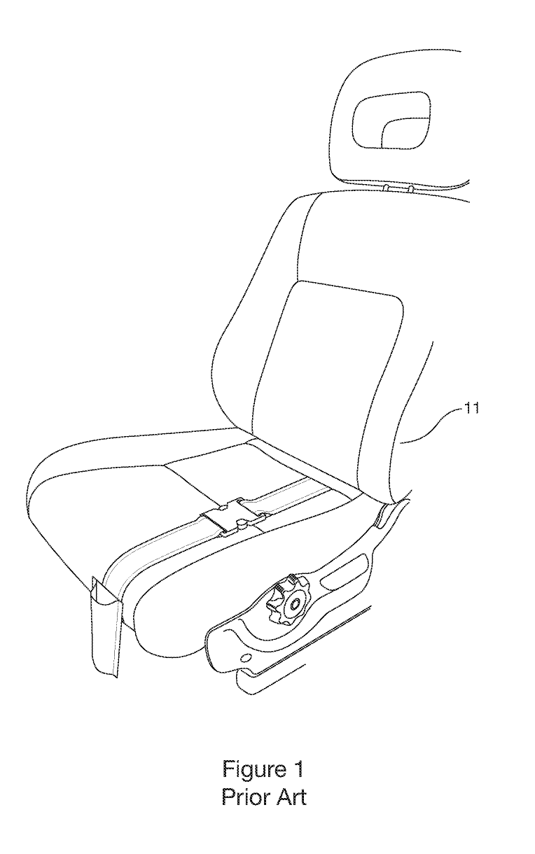

FIG. 2 is a perspective view of an automobile gun holster embodying principles of the invention in a preferred form, shown mounted to an automobile seat.

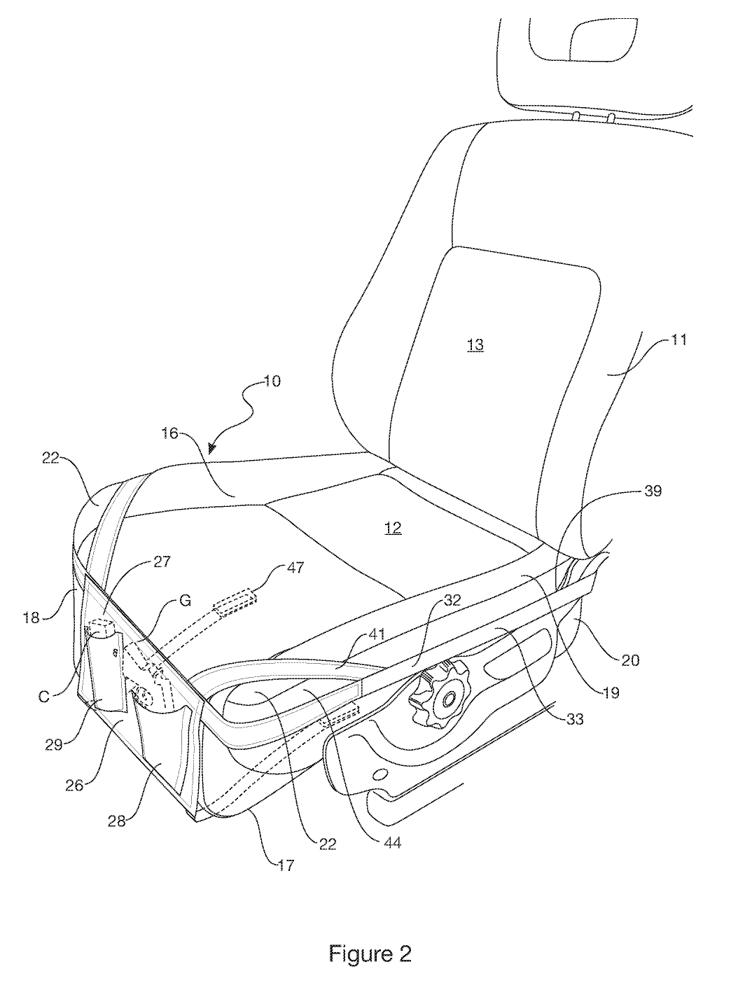

FIG. 3 is a perspective view of the automobile gun holster of FIG. 2.

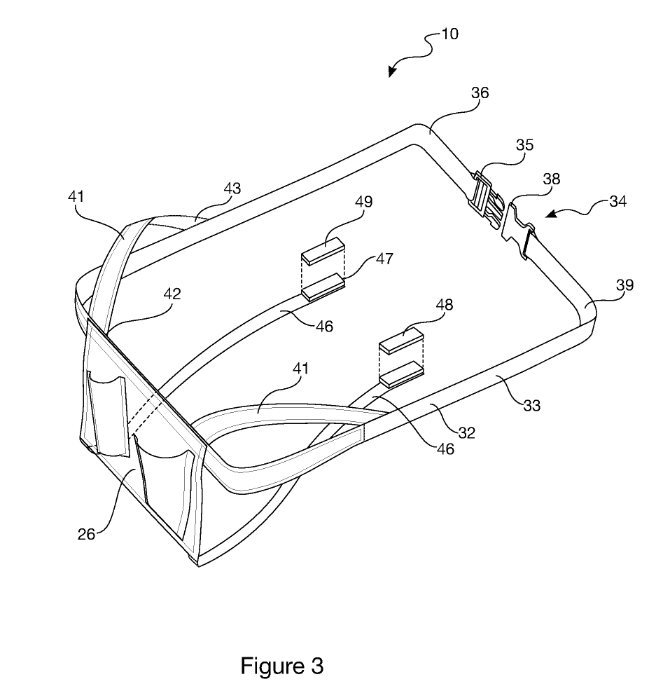

### DETAILED DESCRIPTION

With reference next to the drawings, there is shown an automobile gun holster 10 embodying principles of the invention in a preferred form. The holster 10 is configured to be used in conjunction with an automobile seat 11, which can be in many different forms, configurations, materials and the like.

The automobile seat 11 has a base portion 12 and a backrest portion 13. The base portion 12 has a top surface 16, a bottom surface 17 opposite the top surface 16, a front surface 18, two oppositely disposed side surfaces 19 and a rear surface 20 opposite the front surface 18. The combination of the seat's front surface 18, side surfaces 19 and rear surface 20 may be considered a peripheral side or sidewall surface. The junction between the top surface 16, front surface 18 and side surfaces 19 form two oppositely disposed seat front upper corners 22. The seat may be made of any conventional material, such as leather, cloth, vinyl, or the like.

The holster 10 includes a flexible front portion or apron 26 having a flexible panel or backing 27, a gun pouch, pocket, or holder 28 mounted to the backing 27, and an ammunition clip pouch, pocket, or holder 29 mounted to the backing 27. The gun pouch and clip pouch 28 and 29 are preferably made of an elastic or stretchable type material to allow for the accommodation or holding of different sized or configured guns G and related ammunition clips C. However, the pockets 28 and 29 may also be made of a stiffer material to better fit a particular model or style of gun.

The holster 10 also includes a split or bifurcate side strap 32 which extends from opposite sides of the apron 26. The side strap 32 includes a two piece main portion 33 which includes a two piece adjustable buckle 34 which allows one to vary the length of the main portion 33 of the side strap mounted about the seat 11. The two piece adjustable buckle 34 has a male portion 35 mounted to a first portion 36 of the main strap 33, and a female portion 38 mounted to a second portion 39 of the main strap. The male portion 35 is releasably coupled to the female portion 38. The male portion 35 is shown including an adjustable feature to vary the length of the side strap between the apron 26 and the male portion 35. The adjustability of the length of the side strap 32 allows the side strap to be wrapped about the side perimeter or peripheral sidewall of the seat base portion 12 and tightened to maintain the position of the holster 10 relative to the seat 11.

The side strap 32 also has a top portion 41 which has one end 42 mounted to the top edge of the apron 26 and an opposite end 43 mounted to the strap main portion 33 spaced from or distal the apron 26. The combination of the main portion 33 and each top portion 41 creates a longitudinal split or bifurcation of the side strap which results in a space or opening 44 therebetween.

Lastly, the holster 10 includes a pair of flexible bottom straps 46 which are mounted to and extend from the bottom edge of the apron 26. Each bottom strap 46 includes a first hook and loop type fastener 47 configured to mate with an oppositely configured length of second hook and loop type fastener 48. The second hook and loop type fastener 48 has an adhesive coating 49 which allows it to be mounted to the underside or bottom surface 17 of the seat 11, although it should be understood that the bottom straps may be coupled to the seat in any conventional fashion.

The side strap 32 and bottom straps 46 may be made of any flexible material, such an a woven nylon, leather, cloth, or the like.

In use, the holster 10 is coupled to an automobile seat 11 by wrapping the first portion 36 and second portion 39 of the side strap main portion 33 about the perimeter or peripheral sidewall of the seat base portion 12. As such, the main portion of the side strap 32 contacts the side surfaces 19, the rear surface 20, and perhaps a portion of the front surface 18 of the base portion 12. The male portion 35 of the buckle 34 is then inserted into and coupled to the female portion 38 of the buckle. The free end of the main strap first portion 36 is then pulled to adjust the length of the main portion 33 so as to fit snugly about the periphery of the seat base portion 12. The main portion 33 is positioned in this manner while the top portion 41 of the side strap 32 is placed generally upon the top surface 16 of the seat base portion, so that the seat front upper corners 22 are positioned in and firmly captured within the opening 44 between the section of the main portion 33 and the section of the top portion 41 of the side straps 32 which define the opening 44.

The bottom straps 46 are then pulled beneath the seat 11 so that they overlie the bottom surface 17 of the seat base portion. The second fastener 48 is adhesively mounted to the bottom surface 17 in a position to mate with the first fastener 47 and thereby maintain the position of the bottom straps 46. The bottom straps 46 aid in maintaining the position of the holster by restricting sideways movement as well as upward movement of the apron 26 relative to the seat base portion 12.

The capturing of the seat front upper corners 22 within openings 44 provides stability by preventing the holster from rotating about the periphery of the base portion 12. Furthermore, the positioning of the top portion 41 upon the top surface 16 of the seat base portion 12 prevents that holster from slipping downwardly.

With the gun holster 10 mounted to the base portion 12 of a seat 11, a gun G may be positioned within the gun pocket 28 and an extra ammunition clip C may be positioned in the clip pocket 29. The gun is now positioned between the legs of a person occupying the seat to allow quick and easy access to the gun.

It should be understood that the gun pocket 28 may be angled or tilted from vertical to accommodate for better right or left handed access, i.e., the pocket is offset from vertical so that the gun therein is also offset from vertical. The drawings show a right tilt of the gun pocket 28 for easier right handed access to the gun G.

It thus is seen that a gun holster is now provided which overcomes problems associated with gun holsters of the prior art. While this invention has been described in detail with particular references to the preferred embodiments thereof, it should be understood that many modifications, additions and deletions, in addition to those expressly recited, may be made thereto without departure from the spirit and scope of the invention.

1. An automobile gun holster adapted for use with an automobile seat having a base and a backrest, the automobile gun holster comprising,
a front panel, said front panel including a gun pocket;
a flexible, adjustable side strap coupled to said front panel having a length to be wrapped about the peripheral sidewall of an automobile seat base, said adjustable side strap being adjustable in length to accommodate automobile seat bases of different sizes.

2. The automobile gun holster of claim 1 wherein said adjustable side strap includes a main portion extending about the peripheral sidewall of the automobile seat base and at least one top portion configured to be positioned on top of the automobile seat base and at least coupled at one end to said main portion.

3. The automobile gun holster of claim 2 wherein said adjustable side strap main portion and said adjustable side strap top portion have sections spaced from each other so that a top, front corner of the automobile seat base is captured between said adjustable side strap main portion and said adjustable side strap top portion.

4. The automobile gun holster of claim 1 further comprising at least one bottom strap extending from a bottom edge of said panel and coupleable to the automobile seat base.

5. The automobile gun holster of claim 2 wherein said side strap includes two top portions, each top portion being configured to be positioned on top of the automobile seat base and coupled at least at one end to said main portion so as to capture opposite front top corners of the automobile seat base between said top portions and said main portion.

6. The automobile gun holster of claim 1 further comprising an ammunition clip pocket coupled to said front panel.

7. The automobile gun holster of claim 1 wherein said gun pocket is mounted to said front panel at an angle offset from vertical.

8. An automobile gun holster adapted for use with an automobile seat having a base and a backrest, the automobile gun holster comprising,
a gun pocket;
a flexible, adjustable side strap coupled to said gun pocket and having a length to be wrapped about the peripheral sidewall of an automobile seat base, said adjustable side strap being adjustable in length to accommodate automobile seat bases of different sizes.

9. The automobile gun holster of claim 8 wherein said adjustable side strap includes a main portion extending about the peripheral sidewall of the automobile seat base and at least one top portion configured to be positioned on top of the automobile seat base and coupled at least at one end to said main portion.

10. The automobile gun holster of claim 9 wherein said adjustable side strap main portion and said adjustable side strap top portion have sections spaced from each other so that a top, front corner of the automobile seat base is captured between said adjustable side strap main portion and said adjustable side strap top portion.

11. The automobile gun holster of claim 8 further comprising at least one bottom strap extending from said gun pocket coupleable to the automobile seat base.

12. The automobile gun holster of claim 9 wherein said side strap includes two top portions, each top portion being configured to be positioned on top of the automobile seat base and coupled at least at one end to said main portion so as to capture opposite front top corners of the automobile seat base between said top portions and said main portion.

13. The automobile gun holster of claim 8 further comprising a front panel to which said gun pocket is coupled and an ammunition clip pocket coupled to said front panel.

14. A combination automobile gun holster and automobile seat comprising,
an automobile seat having a base and a backrest, said base having a top surface, a front surface, a rear surface, opposite side surfaces, and a bottom surface, the combination of said top surface, said side surfaces and said front surface defining two oppositely disposed top, front corners;
a front panel overlaying at least a portion of said front surface of said seat base, said front panel including a gun pocket;
a flexible, adjustable side strap coupled to said front panel, said side strap extending about said seat base to overlay said side surfaces and said rear surface of said seat base and thereby hold said automobile gun holster firmly to said seat base.

15. The combination automobile gun holster and automobile seat of claim 14 wherein said adjustable side strap includes a main portion extending about said seat base to overlay said side surfaces and said rear surface of said seat base and at least one top portion configured to be positioned upon said top surface of said seat base.

16. The combination automobile gun holster and automobile seat of claim 15 wherein said adjustable side strap main portion and said adjustable side strap top portion have sections spaced from each other so that said top, front corner of the automobile seat base is captured between said adjustable side strap main portion and said adjustable side strap top portion.

17. The combination automobile gun holster and automobile seat of claim 14 further comprising at least one bottom strap extending from said panel and coupleable to said automobile seat base.

18. The combination automobile gun holster and automobile seat of claim 15 wherein said side strap includes two top portions, each top portion being configured to be positioned upon said top surface of said automobile seat base and coupled at least at one end to said main portion so as to capture said opposite front top corners of said automobile seat base between said top portions and said main portion.

19. The automobile gun holster of claim 14 further comprising an ammunition clip pocket coupled to said front panel.

20. The automobile gun holster of claim 14 wherein said gun pocket is mounted to said front panel at an angle offset from vertical.
